(19) United States
(12) Patent Application Publication
(10) Pub. No.: US 2018/0234623 A1
(43) Pub. Date: Aug. 16, 2018

(54) UTILIZING BIOMETRIC EMOTION CHANGE FOR PHOTOGRAPHY CAPTURE

(71) Applicant: INTERNATIONAL BUSINESS MACHINES CORPORATION, Armonk, NY (US)

(72) Inventors: JAMES E. BOSTICK, CEDAR PARK, TX (US); JOHN M. GANCI, JR., CARY, NC (US); MARTIN G. KEEN, CARY, NC (US); SARBAJIT K. RAKSHIT, KOLKATA (IN)

(21) Appl. No.: 15/429,326

(22) Filed: Feb. 10, 2017

(51) Int. Cl. H04N 5/232; G06K 9/62; G06K 9/00; G04B 47/06; G08C 23/02

(52) U.S. Cl. CPC H04N 5/23219; H04N 5/23206; G06K 9/6288; G06F 3/04842; G04B 47/063; G08C 23/02; H04N 5/23222; G06K 9/00315

(57) ABSTRACT

Embodiments describe a technique for utilizing biometric information to trigger an image capture, the technique includes selecting an emotion to monitor on a smart device disposed on an individual and monitoring the individual for the selected emotion using one or more sensors of the smart device. The technique also includes detecting the selected emotion based on biometric data from the sensors, and responsive to detecting the selected emotion, encoding a notification for broadcasting to an image capture device, the encoded notification indicating the selected emotion and identity of the individual. The technique includes broadcasting the encoded notification to the image capture device to trigger the capture of the image of the individual.

### BACKGROUND

The present invention relates to image photography devices, and more specifically, to utilizing biometric emotion change for photography capture.

In today's environment wearable technology and mobile devices are equipped with several functions including photo taking capability, navigation applications, sensing functions, etc. Devices such as laptops, mobile phones, and tablets are also equipped with picture taking capability. Image capturing devices can capture photos using various functions and devices to assist in capturing an image. For example, image capturing devices can be triggered by timers set by a user or an extension device, such as a selfie-stick to trigger the image capture. Various techniques can be used to trigger an image capture.

### SUMMARY

An embodiment includes a method for utilizing biometric information to trigger an image capture, the technique includes selecting an individual to monitor from an image capture device having a camera application, wherein the individual is wearing a smart device and wherein the image capture device is in communication with the smart device. The method also includes selecting an emotion of the individual to monitor, and receiving an emotion notification from the smart device indicating a detected change corresponding to the selected emotion. The method includes performing an image analysis of the individual using the camera application and triggering the capture of the image of the individual based on the emotion notification and the image analysis of the individual.

Another embodiment includes a system for utilizing biometric information to trigger an image capture, the system includes one or more processors, and at least one memory, the memory including instructions that, upon execution by at least one of the one or more processors, cause the system to perform a method for utilizing biometric information to trigger an image capture. The system performs selecting an individual to monitor from an image capture device having a camera application, wherein the individual is wearing a smart device and wherein the image capture device is in communication with the smart device, and selecting an emotion of the individual to monitor. The system also performs receiving an emotion notification from the smart device indicating a detected change corresponding to the selected emotion, performing an image analysis of the individual using the camera application, and triggering the capture of the image of the individual based on the emotion notification and the image analysis of the individual.

Another embodiment includes a computer program product for utilizing biometric emotion change for image capture, the computer program product includes a computer readable storage medium having stored thereon first program instructions executable by a processor to cause the processor to select an individual to monitor from an image capture device having a camera application, wherein the individual is wearing a smart device and wherein the image capture device is in communication with the smart device. The instructions are further executable by a processor to cause the processor to select an emotion of the individual to monitor, and receive an emotion notification from the smart device indicating a detected change corresponding to the selected emotion. The instructions are further executable by a processor to cause the processor to perform an image analysis of the individual using the camera application and trigger the capture of the image of the individual based on the emotion notification and the image analysis of the individual.

An embodiment includes a method for utilizing biometric information to trigger an image capture, the technique includes selecting an emotion to monitor on a smart device disposed on an individual, and monitoring the individual for the selected emotion using one or more sensors of the smart device. The method also includes detecting the selected emotion based on biometric data from the sensors, and responsive to detecting the selected emotion, encoding a notification for broadcasting to an image capture device, the encoded notification indicating the selected emotion and identity of the individual. The method includes broadcasting the encoded notification to the image capture device to trigger the capture of the image of the individual. In one or more embodiments, the broadcast can be received by one or more image capture devices via ultrasound.

An embodiment includes a system for utilizing biometric emotion change for image capture, the system includes one or more processors, and at least one memory, the memory including instructions that, upon execution by at least one of the one or more processors, cause the system to perform a method for utilizing biometric emotion change for image capture. The system performs selecting an emotion to monitor on a smart device disposed on an individual, and monitoring the individual for the selected emotion using one or more sensors of the smart device. The system also includes detecting the selected emotion based on biometric data from the sensors, and responsive to detecting the selected emotion, encoding a notification for broadcasting to an image capture device, the encoded notification indicating the selected emotion and identity of the individual, and broadcasting the encoded notification to the image capture device to trigger the capture of the image of the individual.

Another embodiment includes a computer program product for utilizing biometric emotion change for image capture, the computer program product including a computer readable storage medium having stored thereon first program instructions executable by a processor to cause the processor to selecting an emotion to monitor on a smart device disposed on an individual, and monitoring the individual for the selected emotion using one or more sensors of the smart device. The instructions are further executable by a processor to cause the processor to detect the selected emotion based on biometric data from the sensors, and responsive to detecting the selected emotion, encode a notification for broadcasting to an image capture device, the encoded notification indicating the selected emotion and identity of the individual. The instructions are further executable by a processor to cause the processor to broadcast the encoded notification to the image capture device to trigger the capture of the image of the individual.

### BRIEF DESCRIPTION OF THE DRAWINGS

FIG. 1 provides a block diagram illustrating an example processing system for practice of the teachings herein;

FIG. 2 provides an image capture system for utilizing biometric emotion change for photography capture in accordance with an embodiment;

FIG. 3 provides a smart device used in an image capture system for utilizing biometric emotion change for photography capture in accordance with an embodiment;

FIG. 4 provides an image capture device used in image capture system for utilizing biometric emotion change for photography capture in accordance with an embodiment;

FIG. 5 provides a method for utilizing biometric emotion change for photography capture in accordance with an embodiment;

FIG. 6 provides a smart device used in an image capture system provides a method for utilizing biometric emotion change for photography capture in accordance with an embodiment; and

FIG. 7 provides a method for utilizing biometric emotion change for photography capture in accordance with an embodiment.

### DETAILED DESCRIPTION

The technique described herein provides utilizing a combination of smart watch sensors and a camera application on a mobile device to capture candid photographs of a selected smart watch user. The technique further describes a method for detecting when the smart watch user experiences a change in emotion and automatically captures a candid photograph on a mobile device of the smart watch user as they experience an emotional change.

Advances in biometric analysis have made it possible to detect and identify when a person is experiencing a particular emotion through analysis of a combination of biometric, movement, and speech pattern data. This provides the opportunity to be alerted to when a user is displaying a particular emotion and to capture this emotion in a candid photograph.

The disclosure describes a method whereby a smart watch is used to capture data regarding an individual's emotions, where the data is analyzed to determine the emotion the individual is experiencing, and a mobile device camera application is alerted to capture a picture of the individual as the t experiences this emotional change.

In accordance with exemplary embodiments of the disclosure, methods, systems and computer program products for utilizing biometric emotion change for photography capture is provided. In one embodiment, a smart watch can broadcast notifications to an image capture device. The image capture device can be positioned on a selfie-stick, tripod, or another device to take the photograph of the smart watch user. Instead of using a timer to capture an image, a smartwatch can be used to trigger the automatic capture of an image capture device. In one or more embodiments, a smart watch is used to control the image capturing system.

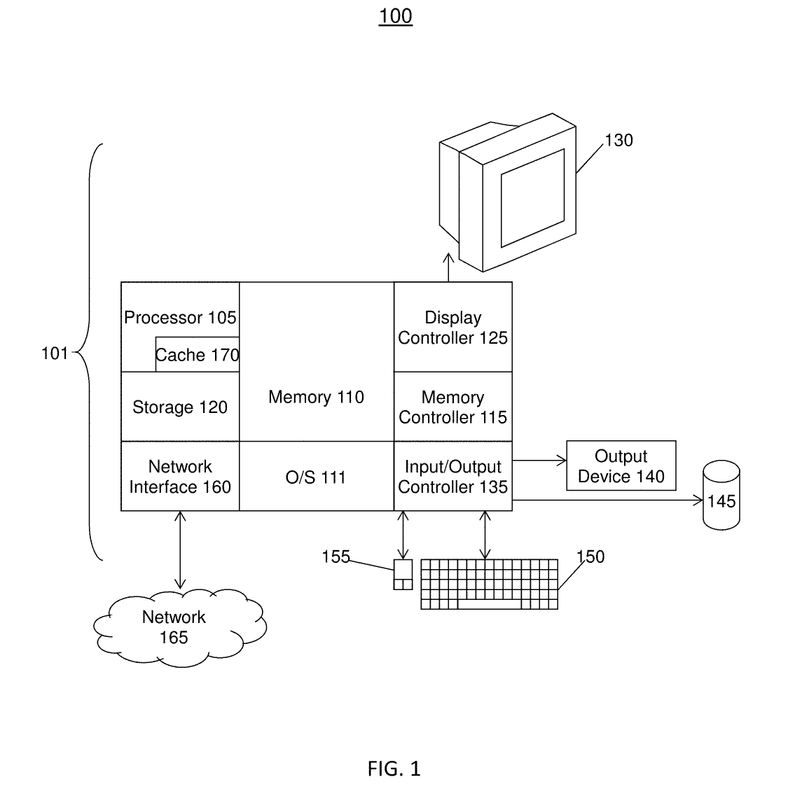

In an exemplary embodiment, in terms of hardware architecture, as shown in FIG. 1, the computer 101 includes a processor 105. The computer 101 further includes memory 110 coupled to a memory controller 115, and one or more input and/or output (I/O) devices 140, 145 (or peripherals) that are communicatively coupled via a local input/output controller 135. The input/output controller 135 can be, for example, but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in storage 120, such as cache storage, or memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another but can be accessed by the processor 105.

The instructions in memory 110 may include one or more separate programs, each of which comprises an ordered listing of executable instructions for implementing logical functions. The instructions in the memory 110 a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example, but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or another similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to fetch and execute instructions stored within the memory 110, to communicate data to and from the memory 110, and to generally control operations of the computer 101 pursuant to the instructions.

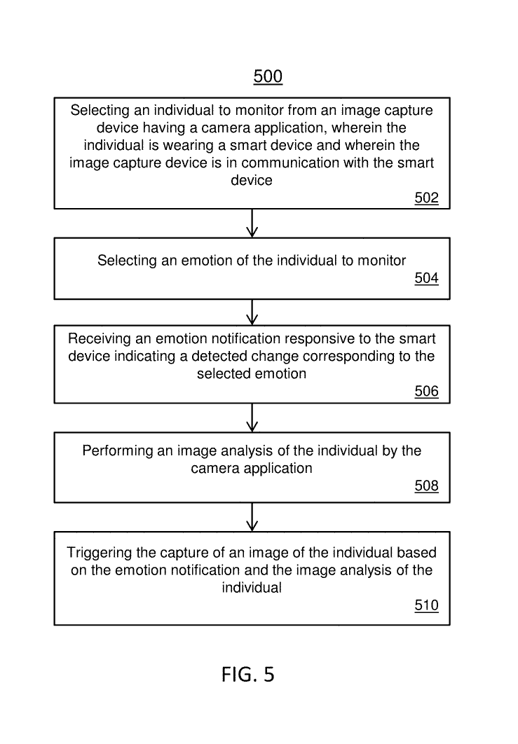

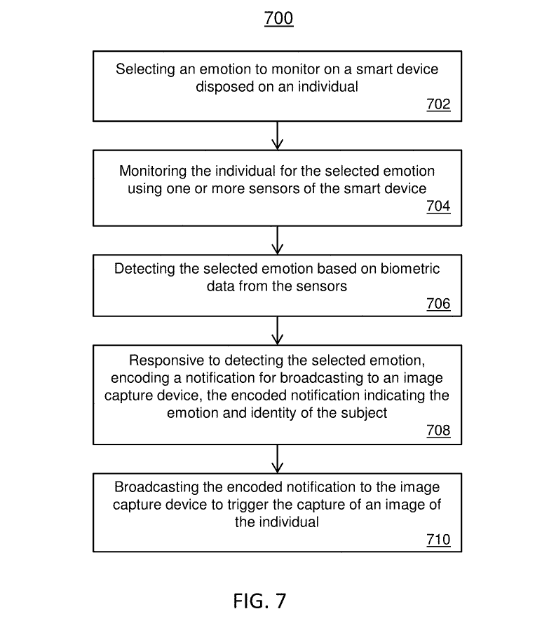

In an exemplary embodiment, where the utilizing biometric emotion change for photography capture is implemented in hardware, the methods described herein, such as processes 500 and 700 of FIGS. 5 and 7, can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

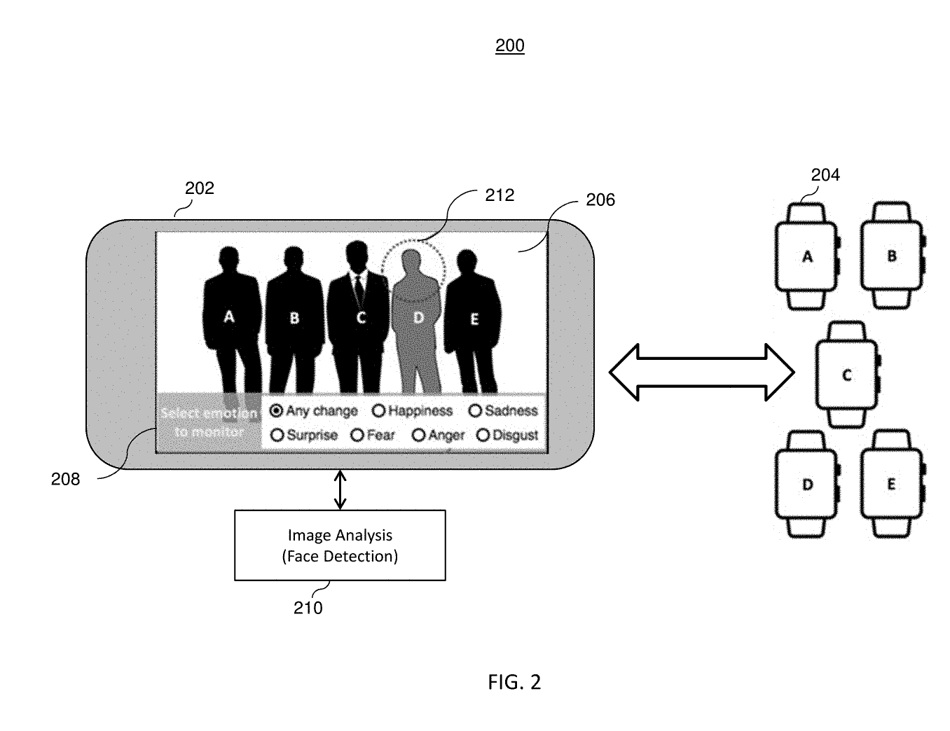

Referring to FIG. 2, a system 200 for utilizing biometric information to trigger an image capture is provided. The system 200 includes an image capture device 202 and smart devices 204 A-E. In one or more embodiments, the image capture device 202 can be a smartphone or tablet having a camera application with picture taking capabilities. The image capture device 202 is configured with an image analysis module 210 for performing an image analysis for individuals that are positioned within the frame of the display 206 of the image capture device 202. The image analysis includes performing a facial detection process for individuals in the display 206. In an embodiment, the facial detection process is performed on those smart watch users' that are paired with the image capture device 202. The image capture device 202 is equipped with a touch screen interface for receiving inputs from a user. In one or more embodiments, the image capture device 202 can be configured with voice control for controlling the image capture device 202 by an audio command of a user.

The camera application of image capture device 202 includes an interface for selecting an individual as a target to trigger the image capture. The camera application also includes an interface 208 for selecting an emotion of the selected individual to monitor to trigger the image capture. As a non-limiting example, emotions include happiness, sadness, surprise, fear, anger, and disgust. Other emotions are thought to be within the scope. In one or more embodiments, the selection of the individual and the emotion can be executed by the touchscreen interface as shown in display 206 or by voice control. In this example, the display 206 is aimed at a number of smart device users A-E where each user is wearing a corresponding smart device 204 A-E, respectively. The display 206 indicates smart device user D has been selected for monitoring an emotion change. The image capture device also includes an image analysis module 210 for performing a face detection of a selected smart watch user. In an embodiment, the emotion change detected by a respective smart device and the image analysis performed by the image capture device 202 can trigger an image capture by the image capture device 202.

Smart devices 204 can be a smart watch being worn by an individual. In one or more embodiments, smart devices 204 includes one or more sensors, microphones, speakers, network connection capability (include Wi-Fi and Bluetooth), accelerometers and gyroscopes, and more.

Smart devices include biometric sensors for measuring a pulse, temperature, blood pressure, and other characteristics of a user. Biometric sensors can also be used to measure other physiological characteristics such as an ECG for measuring heart rate. For example, an increased heart can be used to indicate an excited state. The biometric sensors discussed are a non-limiting example of the sensors to be considered within the scope.

Smart device 204 includes motion sensors such as accelerometers and gyroscopes. The information informs the system of the movement of the smart device user. It is known to one having ordinary skill in the art that user movement can indicate an emotion of the user. In addition, biometrics can be used for detecting an emotion of the user.

The smart device 204 also includes a microphone for receiving audio information and voice commands of the user. In one or more embodiments, the smart device 204 is configured to operate in a passive listening mode to use the gathered information in combination with other sensor information to determine an emotion change of the smart watch user. A microphone can detect the frequency of the pitch of the user to determine a current state and emotional change of a user. For example, a lower tone and/frequency can indicate a sad emotion and a higher tone and/or frequency can indicate an excited or stressful emotion. In one or more embodiments, a combination of the speech signal and physiological measures can be combined to determine an emotional state.

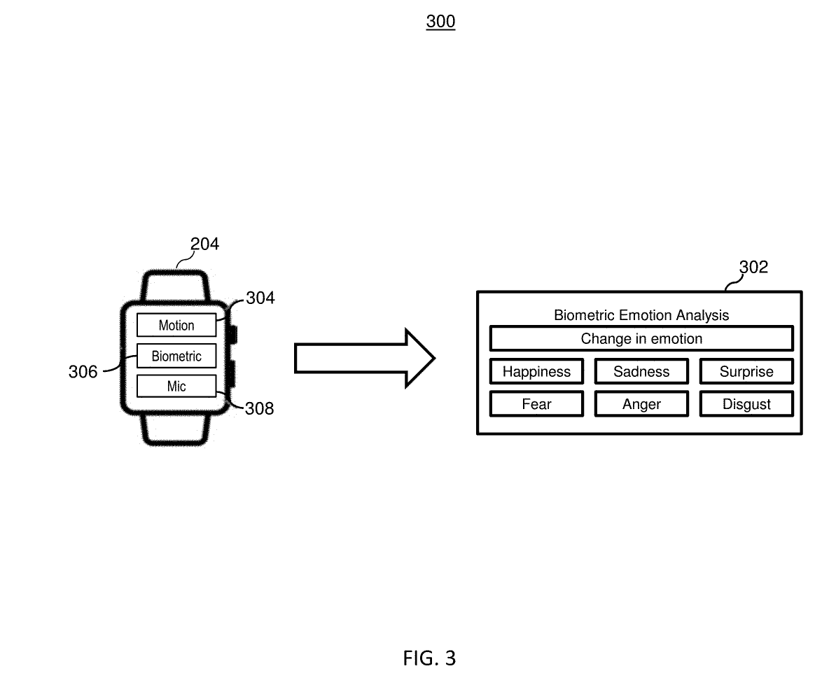

Now referring to FIG. 3, a smart device 204 as shown in system 200 is provided. The smart device 204 is shown as a smart watch having one or more sensors, such as motion sensors 304 and biometric sensors 306, a microphone 308, and speakers. The smart watch has network communication capability for communicating with other devices and networks. The smart device 204 is configured with an interface for communicating with the image capture device. The smart watch includes Bluetooth, Wi-Fi, and ultrasound connectivity among others. In one or more embodiments, data exchanged with the image capture device 202 includes notifications based on biometric emotion analysis module 302. FIG. 3 also provides a biometric emotion analysis module 302 for determining an emotion and a change in emotion.

The biometric emotion analysis module 302 combines the data received from the one or more sensors and microphones to determine an emotional change of the smart watch user. After the data is analyzed and an emotion state or changed is determined, the smartwatch 204 can transmit a notification to an image capture device to trigger an image capture of the smart watch user.

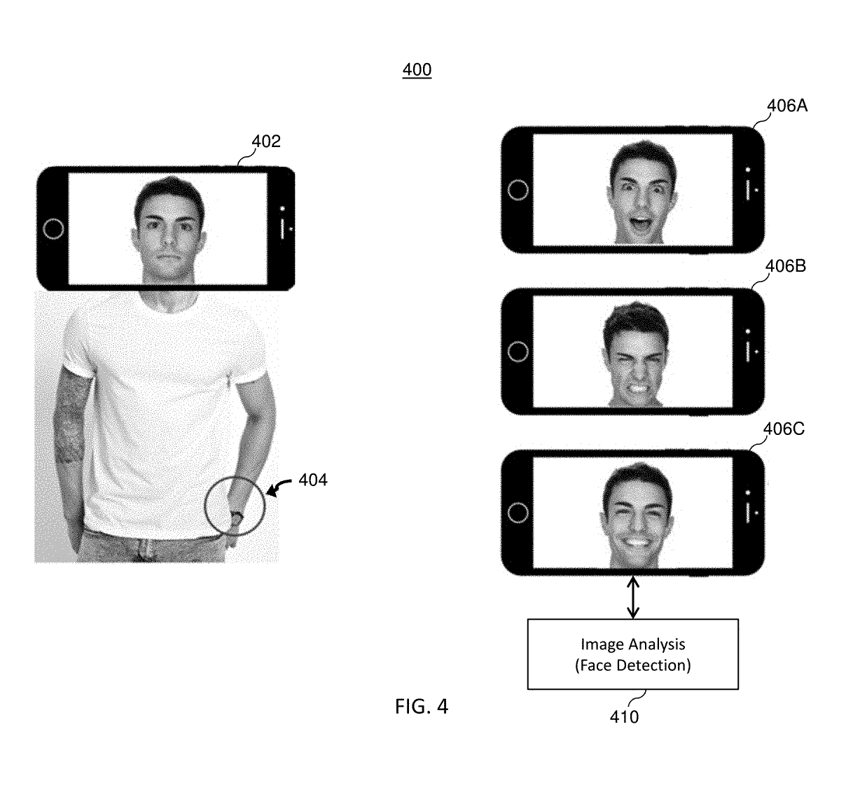

FIG. 4 provides a scenario for utilizing biometric emotion change for photography capture in accordance with an embodiment.

In an example, a selected individual wearing a smart watch that is paired to a smartphone is provided. The smart watch has been paired with the smartphone over a Bluetooth connection. Once the smartwatch and smartphone have been paired, the smart watch user and the emotion to be monitored can be selected. As the smartphone is aimed towards the smart watch user and the smartwatch user is positioned within a frame of the smartphone, an image analysis can be performed. In one or more embodiments, responsive to determining the camera application is open on the smartphone device and the smart watch user is positioned within a frame of the smartphone, the smartphone can automatically focus in on the smart watch user.

The smart watch is configured to detect the current state of the smart watch user using the one or more sensors and the microphone and further detects any change from the current state. Upon detecting a change indicative of the desired emotional state to be monitored a notification will be transmitted from the smart watch to the smartphone to trigger the capturing of the image. Based on the notification from the smartwatch 404 and the image analysis 410 of the smart watch user performed by the smartphone 402, an image of the smart watch user will be taken to capture the image at the moment of the change of the emotion.

Smartphone 406A provides an image of the smart watch user. The image of the smart watch user shown in the display 402 is a neutral emotion for the smart watch user. Smartphone 406A indicates a surprise emotion. Upon the smartphone detecting the emotion change of the smart watch user, the camera of the smartphone automatically takes the picture at that instant based on the detect emotion change being the desired emotion to monitor. Smartphone 406B provides an example image of an angry face associated with an upset emotion and smartphone 406C provides an image of a happy face associated with a joyful emotion. Each smartphone 406 A-C includes an image analysis module 410 for performing a face detection of a selected smart watch user. The face detection is used in combination with the received notification to determine a current state and/or an emotional change of the smart watch user.

Now referring to FIG. 5, a method 500 for utilizing biometric information to trigger an image capture in accordance with an embodiment is shown. Block 502 provides selecting an individual to monitor from an image capture device having a camera application, wherein the individual is wearing a smart device and wherein the image capture device is in communication with the smart device. In one or more embodiments, the smart device and the image capture device are paired over a Bluetooth connection for communication. In one or more embodiments, the image capture device can be simultaneously connected to multiple smart devices for triggering the automatic capture. The selection of the smart watch user can be determined from a touchscreen selection of the individual appearing in the frame of the image capture device. In another embodiment, the selection may occur by a voice command. In one or more embodiments, the biometric information includes the data captured by the sensors and microphones of a smartwatch device used to determine a current state and change in emotional state of the smart watch user.

Block 504 provides selecting an emotion of the individual to monitor. In one or more embodiments, the selected emotion can detect any change in emotion from the current state of the individual. A non-exhaustive list of emotions includes happiness, sadness, surprise, fear, anger, and disgust.

Block 506 provides receiving an emotion notification responsive to the smart device indicating a detected change corresponding to the selected emotion. In one or more embodiments, the smart device uses the one or more sensors and microphones to detect a change in emotion from the current state. If the detected emotion matches the selected emotion of the individual an emotion notification will be transmitted from the smart device to an image capture device over a connection (such as Bluetooth, ultrasound, or other known connection).

Block 508 provides performing an image analysis of the individual by the camera application. In one or more embodiments, the image analysis performs a facial detection process for the selected smart watch user. The image capture device can focus on the selected smart watch user's face to detect facial features that are associated with different emotions, such as smiles, furrowed brows, tears, and other characteristics that are associated with respective emotions. In one or more embodiments, the image capture device can focus on multiple smart watch users' faces. In a different embodiment, the image capture device can trigger the photo when the majority of multiple smart watch users' faces indicate a desired emotion.

Block 510 provides triggering the capture of an image of the individual based on the emotion notification and the image analysis of the individual. In an example, the emotion notification received from the smart device is processed by the image capture device where the image capture device receives and decodes the emotion notification to trigger the image capture, where the emotion notification indicates the smart device user has expressed the selected emotion as detected by the smart device. In an embodiment, the image capture device is triggered to capture the image using both a combination of the emotion notification and the image analysis determining the selected smart device user is expressing the selected emotion.

In one or more embodiments, a request is transmitted to the smart device from the image capture device to receive emotion notification of the selected emotion responsive to selecting the individual and selecting the emotion. In one or more embodiments the request is transmitted over a connection used to pair the smart device and the image capture device.

In one or more embodiments, the triggering of the image capture includes determining the camera application of the image capture device is open and further determining a position of the individual is within the frame of the image capture device. In another embodiment, if the camera application is unavailable, a message is provided on the image capture device indicating a manual capture of the individual is recommended. In an embodiment, if the individual is not positioned within the frame of the image capture device, a message can be provided on the image capture device indicating a manual capture of the individual is recommended.

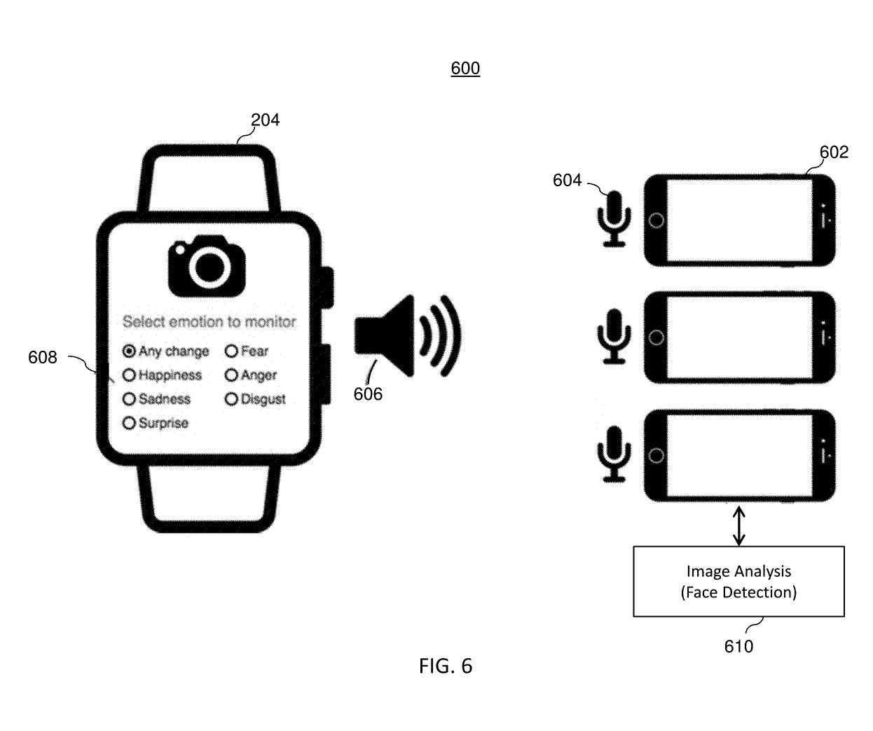

FIG. 6 shows a system 600 for utilizing biometric information to trigger an image capture in accordance with another embodiment. Smart device 204 includes a display 608 where an emotion can be selected to broadcast a notification or request to capture a photograph. In an embodiment, the selection can be selected with by an application on the smart watch. In one embodiment, the emotion can be selected by the touchscreen interface of a smart watch. Alternatively, the emotion can be selected by a voice command or other input means. Smart device 204 includes one or more sensors, microphones and networking capabilities. Smartwatch 204 also includes a speaker 606 for broadcasting the encoded notification. The speaker 606 is configured to broadcast the encoded notification over ultrasound to nearby devices 602.

In one or more embodiments, the nearby devices 602 are configured with a receiver 604 for receiving the encoded broadcast. The nearby device 602 can decode the received broadcast and can be used to trigger an image capture by the nearby device. Nearby devices are also configured with image analysis module 610 for performing the facial detection of the smart device user.

In a scenario, a smart watch user selected an emotional change to broadcast. The smart watch can broadcast the pre-selected change in a user's emotion over an ultrasound connection. Any number of nearby listening mobile devices can receive the broadcast if the mobile devices are equipped to receive and decode the broadcast. In one or more embodiments, devices that are not paired with the smart watch can receive the broadcasted notification indicating a user's change in emotion. Any one or more of the smart devices is capable of receiving the broadcast and using the broadcast to trigger an image capture.

Now referring to FIG. 7, a method 700 for utilizing biometric information to trigger an image capture in accordance with a different embodiment is provided. Block 702 provides selecting an emotion to monitor on a smart device disposed on an individual. In one or more embodiments, the smartwatch includes a touchscreen interface for selecting an emotional change. In a different embodiment, the smart watch user can select the emotional change via a voice command.

Block 704 provides monitoring the individual for the selected emotion using one or more sensors of the smart device. In one or more embodiments, data from the microphone can indicate an emotional state. In a different embodiment, a combination of the one or more sensor data and the data captured by the microphone can indicate an emotional state.

Block 706 provides detecting the selected emotion based on biometric data from the sensors. In one or more embodiments, a smart device can use its sensors, microphones, and other equipment to determine a change in an emotion of the user.

Block 708 provides responsive to detecting the selected emotion, encoding a notification for broadcasting to an image capture device, the encoded notification indicating the emotion and identity of the subject. In one or more embodiments, the notification is encoded and transmitted over ultrasound. Devices having decoders can receive the broadcast. In an embodiment, the identity of the subject can include the name of the subject and/or an image of the subject.

Block 710 provides broadcasting the encoded notification to the image capture device to trigger the capture of an image of the individual. In one or more embodiments, the image capture device can be triggered to capture an image of the smart device user based on the broadcast and/or the broadcast

If the camera application on the image capture device is open and the image analysis detects the subject is within a frame of the image capture device, the camera application can automatically focus on the smart watch user and take the image. Alternatively, if the camera application is not open and/or the smart watch user is not positioned in the frame, a notification can be provided to the image capture device. In an example, the notification can provide a recommendation to manually capture the image. The notification can also recommend opening the camera application if closed or recommend re-positioning the camera to include the smart watch user within the frame.

The use of the smart watch biometric and movement sensors combined with passive listening are used to detect the smart watch wearer's current emotional state and any changes to that emotional state. When the initially determined emotional state changes, mobile devices can be alerted in order to capture a candid picture of the subject as they experience the emotional change.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for utilizing biometric information to trigger an image capture, the method comprising:
selecting an emotion to monitor on a smart device disposed on an individual;
monitoring the individual for the selected emotion using one or more sensors of the smart device;
detecting the selected emotion based on biometric data from the sensors;
responsive to detecting the selected emotion, encoding a notification for broadcasting to an image capture device, the encoded notification indicating the selected emotion and identity of the individual; and
broadcasting the encoded notification to the image capture device to trigger the capture of the image of the individual.

2. The computer-implemented method of claim 1, wherein the encoded notification is encoded and transmitted over ultrasound.

3. The computer-implemented method of claim 1, wherein the encoded notification includes at least one of an emotional state of the individual, name of the individual, and picture of the identity of the individual.

4. The computer-implemented method of claim 1, wherein the encoded notification is broadcasted from a speaker of the smart device, wherein the broadcast is inaudible to humans.

5. The computer-implemented method of claim 1, wherein the smart device is a smart watch device.

6. The computer-implemented method of claim 1, wherein the sensors include at least one of biometric sensors, movement sensors, and microphones.

7. The computer-implemented method of claim 1, further comprising detecting any noticeable change in emotion and detecting a specific change in emotional state.

8. A system for utilizing biometric emotion change for image capture, comprising:
one or more processors; and
at least one memory, the memory including instructions that, upon execution by at least one of the one or more processors, cause the system to perform a method for utilizing biometric emotion change for image capture, the method comprising:
selecting an emotion to monitor on a smart device disposed on an individual;
monitoring the individual for the selected emotion using one or more sensors of the smart device;
detecting the selected emotion based on biometric data from the sensors;
responsive to detecting the selected emotion, encoding a notification for broadcasting to an image capture device, the encoded notification indicating the selected emotion and identity of the individual; and
broadcasting the encoded notification to the image capture device to trigger the capture of the image of the individual.

9. The system of claim 8, wherein the encoded notification is encoded and transmitted over ultrasound.

10. The system of claim 8, wherein the encoded notification includes at least one of an emotional state of the individual, name of the individual, and picture of the identity of the individual.

11. The system of claim 8, wherein the encoded notification is broadcasted from a speaker of the smart device, wherein the broadcast is inaudible to humans.

12. The system of claim 8, wherein the smart device is a smart watch device.

13. The system of claim 8, wherein the sensors include at least one of biometric sensors, movement sensors, and microphones.

14. The system of claim 8, further comprising detecting any noticeable change in emotion and detecting a specific change in emotional state.

15. A computer program product for utilizing biometric emotion change for image capture, the computer program product comprising:
a computer readable storage medium having stored thereon first program instructions executable by a processor to cause the processor to:
select an emotion to monitor on a smart device disposed on an individual;
monitor the individual for the selected emotion using one or more sensors of the smart device;
detect the selected emotion based on biometric data from the sensors;
responsive to detecting the selected emotion, encode a notification for broadcasting to an image capture device, the encoded notification indicating the selected emotion and identity of the individual; and
broadcast the encoded notification to the image capture device to trigger the capture of the image of the individual.

16. The computer program product of claim 15, wherein the encoded notification is encoded and transmitted over ultrasound.

17. The computer program product of claim 15, wherein the encoded notification includes at least one of an emotional state of the individual, name of the individual, and picture of the identity of the individual.

18. The computer program product of claim 15, wherein the encoded notification is broadcasted from a speaker of the smart device, wherein the broadcast is inaudible to humans.

19. The computer program product of claim 15, wherein the smart device is a smart watch device.

20. The computer program product of claim 15, wherein the instructions are further executable by a processor to cause the processor to detect any noticeable change in emotion and detecting a specific change in emotional state.
